(19) United States
(12) Patent Application Publication
(10) Pub. No.: US 2012/0050950 A1
(43) Pub. Date: Mar. 1, 2012

(54) Lithium ion capacitor

(75) Inventors: Hak Kwan Kim, Hanam-si (KR); Bae Kyun Kim, Seongnam-si (KR); Hong Seok Min, Yongin-si (KR); Dong Hyeok Choi, Suwon-si (KR)

(73) Assignee: SAMSUNG ELECTRO-MECHANICS CO., LTD., Suwon (KR)

(21) Appl. No.: 13/137,562

(22) Filed: Aug. 25, 2011

(30) Foreign Application Priority Data
Aug. 31, 2010 (KR) 10-2010-0084817

(51) Int. Cl. H01G 9/035

(52) U.S. Cl. 361/505

(57) ABSTRACT

Provided is a lithium ion capacitor. The lithium ion capacitor includes cathodes and anodes alternately disposed with the separators interposed therebetween. The cathode comprises a cathode collector and a cathode active material layer made of a first cathode active material layer disposed on at least one surface of the cathode collector and made of carbon/lithium metal oxide and a second cathode active material made of charcoal.

### CROSS-REFERENCE TO RELATED APPLICATIONS

This application claims the benefit of Korean Patent Application No. 10-2010-0084817 filed with the Korea Intellectual Property Office on Aug. 31, 2010, the disclosure of which is incorporated herein by reference.

### BACKGROUND OF THE INVENTION

1. Field of the Invention

The present invention relates to a lithium ion capacitor, and more particularly, to a lithium ion capacitor including a cathode active material layer containing a first active material made of composite material of carbon/lithium metal oxide and a second active material made of charcoal.

2. Description of the Related Art

In general, electrochemical energy storage devices are core parts of finished products, which are essentially used in all mobile information communication devices and electronic devices. In addition, the electrochemical energy storage devices will be used as high quality energy sources in new and renewable energy fields that can be applied to future electric vehicles and mobile electronic devices.

The electrochemical energy storage devices, typically, a lithium ion battery and an electrochemical capacitor, use an electrochemical theory.

Here, the lithium ion battery is an energy device that can be repeatedly charged and discharged using lithium ions, which has been researched as an important power source having higher energy density per unit weight or unit volume than the electrochemical capacitor. However, the lithium ion battery is difficult to be commercialized due to low stability, short use time, long charge time, and small output density.

In recent times, since the electrochemical capacitor has lower energy density but better instant output and longer lifespan than the lithium ion battery, the electrochemical capacitor is being rapidly risen as a new alternative that can substitute for the lithium ion battery.

In particular, a lithium ion capacitor among the electrochemical capacitors can increase energy density without reduction in output in comparison with other electrochemical capacitors, attracting many attentions.

Since the lithium ion capacitor has an anode with an electrostatic capacitance per unit volume greater than approximately 3 to 4 times that of a cathode, the thickness of the cathode must be formed larger than 3 to 4 times that of the anode.

Accordingly, since the cathode is formed to be relatively thicker than the anode, although the conductive material is uniformly distributed in the cathode, the output property of the lithium ion capacitor is deteriorated by increasing the inner resistance.

### SUMMARY OF THE INVENTION

The present invention has been invented in order to overcome the above-described problems and it is, therefore, an object of the present invention to provide a lithium ion capacitor capable of reducing the thickness of a cathode by increasing the electrostatic capacitance of the cathode by including a cathode active material layer having a first active material made of a composite material of carbon/lithium metal oxide and a second active material made of charcoal.

In accordance with one aspect of the present invention to achieve the object, there is provided a lithium ion capacitor including cathodes and anodes alternately disposed with the separators interposed therebetween,
wherein the cathode comprises a cathode collector and a cathode active material layer made of a first cathode active material layer disposed on at least one surface of the cathode collector and made of carbon/lithium metal oxide and a second cathode active material made of charcoal.

And also, the carbon includes any one among a carbon nano tube and a graphene.

And also, the cathode active material layer further includes a conductive material.

And also, the conductive material includes any one among carbon black, acetylene black, graphite and metal powder.

And also, the anode includes an anode collector and an anode active material layer disposed at least one surface of the anode collector.

And also, the anode active material layer includes any one among natural graphite, artificial graphite, graphitized carbon fiber and hard carbon and a carbon nano tube.

And also, the anode active material pre-dopes lithium ions.

And also, the second active material has a weight ratio of 1 to 5 times in comparison with the first active layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a lithium ion capacitor in accordance with a first exemplary embodiment of the present invention;

FIG. 2 is an assembled perspective view of the lithium ion capacitor shown in FIG. 1;

FIG. 3 is a cross-sectional view of an electrode cell of FIG. 1; and

FIG. 4 is an enlarged view of an A region shown in FIG. 3.

### DETAILED DESCRIPTION OF THE PREFERABLE EMBODIMENTS

Hereinafter, embodiments of the present invention for a lithium ion capacitor will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

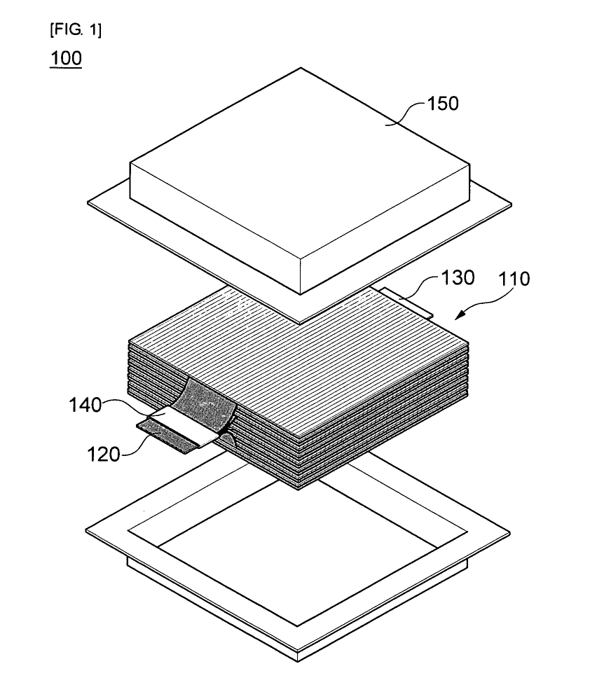

FIG. 1 is an exploded perspective view of a lithium ion capacitor in accordance with a first exemplary embodiment of the present invention.

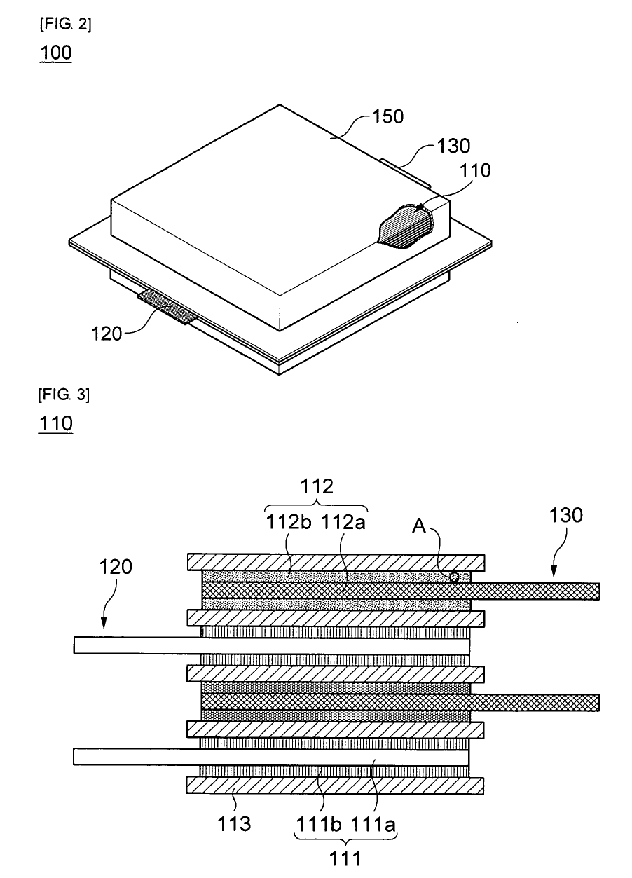

FIG. 2 is an assembled perspective view of the lithium ion capacitor shown in FIG. 1.

FIG. 3 is a cross-sectional view of an electrode cell of FIG. 1.

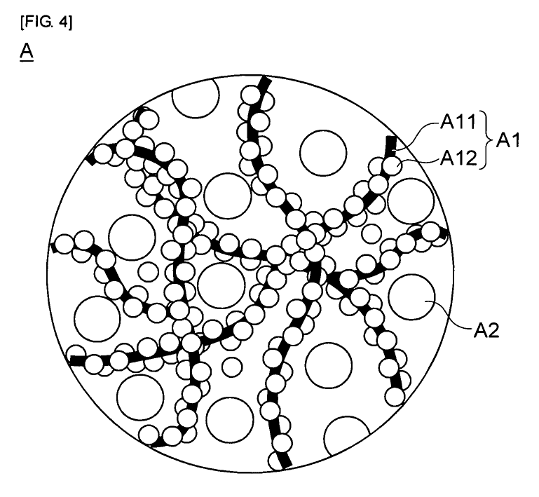

FIG. 4 is an enlarged view of an A region shown in FIG. 3.

Referring to FIGS. 1 to 4, a lithium ion capacitor 100 in accordance with a first exemplary embodiment of the present invention may include a housing 150, an electrode cell sealed by the housing 150, and an electrolyte in which the electrode cell 110 is immersed.

The electrode cell 110 may include cathodes 111 and anodes 112, which are alternately disposed with separators 113 interposed therebetween. At this time, the cathodes 111 and the anodes 112 may partially overlap each other.

Here, in the electrochemical capacitor, i.e., the lithium ion capacitor, the cathode 111 may be referred to as a positive electrode. In addition, the anode 112 may be referred to as a negative electrode.

The cathode 111 may include a cathode collector 111a and a cathode active material layer 111b disposed on at least one surface of the cathode collector 111a.

The cathode collector 111a may be formed of a metal, for example, one of aluminum, stainless, copper, nickel, titanium, tantalum and niobium or an alloy of two or more. The cathode collector 111a may have a thin film shape or a mesh shape.

The cathode active material layer 111b may be formed of a first active material A1 made of a composite material of carbon/lithium metal oxide and a second active material A2 made of charcoal.

As the first active material Al is made of the composite material of a lithium metal oxide A12 and a carbon material A11, it can improve the capacity and the output property at the same time. That is, as the lithium metal oxide A12 stores the energy through the movement of the lithium ion by being oxidized and deoxidized, it may have the capacitance larger than the charcoal to store the energy by the surface adsorption. Here, the examples of the lithium metal oxide A12 are LiMn₂O₄ or LiMnO₂.

And also, since the carbon material A11 is made of a material having a high conductivity, e.g., any one among carbon nano-tube or grapheme, it can increase the output property by reducing the electric resistance through the electrical connection between the lithium metal oxide A12 and the cathode collector 111a.

In addition, as the lithium metal oxide A12 is adsorbed to the carbon material A11 constituting of the network entangled with each other, it can further increase the output property by distributing the lithium metal oxide A12 and the carbon material A11 uniformly and being connected to the cathode collector 111a. At this time, as the lithium metal oxide A12 has a nano size, it can increase the speed of charging and discharging.

However, when the cathode active material layer 111b includes only the first active material A1, the slurry is not easily manufactured due to the aggregation phenomenon between carbon materials A11 as well as it cannot play a role of the conductive material to reduce the resistance between the particles of the lithium metal oxide A12.

In order to solve this, for preventing the aggregation phenomenon between the carbon materials A11 , the cathode active material layer 111b further includes the second active material A2. Here, as the second active material A2 is included, in the slurry for forming the cathode active material layer 111b, the amount of the first active material A1 can be reduced, which will, in turn, it plays a role of preventing the aggregation between the first active materials. That is, as the contents of the first active material A1 is reduced in the cathode active material layer 111b, the corrugation phenomenon between the first active materials A1 can be prevented in advance. At this time, the charcoal is the example of the material to form the second active material A2. And also, since the charcoal can store the energy by the surface adsorption, it can increase the speed of the charging and discharging in comparison with the first active material A1. That is, the second active material A2 can prevent the first active material A1 from being corrugated during the manufacturing the slurry as well as can play a role of increasing the speed of charging and discharging.

The second active material A2 may have a weight ratio of 1 to 5 times in comparison with the first active material A1. Here, if the second active material has the weight ratio below one time in comparison with the first active material, the slurry is not easily manufactured due to the corrugation of the first active material A1. Whereas, if the second active material A2 exceeds 5 times in comparison with the first active material A1, there is no effect in increasing the capacitance of the cathode active material layer 111b.

In addition, the cathode active material layer 111b can further include a conductive material to further increase the characteristics of electric conductivity. At this time, the conductive materials may include any one among, e.g., carbon black, acetylene black, graphite and metal powder.

In addition, the cathode active material layer 111b may further include a binder. Here, the binder may be formed of a material, for example, one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on.

In addition, the cathode 111 may include a cathode terminal 120 to be connected to an external power. The cathode terminal 120 may be extended from the cathode collector 111a. Here, since the cathode terminal 120 may be stacked with a plurality of numbers by being extended from each of the cathode collectors 111a, the stacked cathode terminal 120 may be unified by an ultrasonic bonding to be easily contact with the external power. In addition, the cathode terminal may be connected to an external terminal by the bonding or the welding by providing the additional external terminal on the cathode terminal 120.

The anode 112 may include an anode collector 112a and an anode active material layer 112b disposed on both surfaces of the anode collector 112a, respectively.

Here, the anode collector 112a may be formed of a metal, for example, one of copper, nickel and stainless. Although the anode collector 112a may have a thin film shape, the anode collector 112a may provide a plurality of througholes for a uniform doping process with effectively performing the movement of ions.

And also, the anode active material layer 112b may include carbon material to reversely dope and dedope the lithium ions, e.g., any one among natural graphite, artificial graphite, graphitized carbon fiber and hard carbon and a carbon nano tube.

And also, the lithium ions may be pre-doped in the anode active material layer 112b. Accordingly, since the potential of the anode 112 can be reduced approximately to the potential of the lithium, i.e., 0V, the energy density of the lithium ion capacitor can be increased. At this time, the potential of the anode 112 may be controlled by controlling the pre-doping of the ions.

Here, the anode 112 may include the anode terminal 130 for being connected to the external power. At this time, the anode terminal 130 may be formed by being extended in the one side of the anode collector 112a. That is, the anode collector 112a and the anode terminal may be formed in one body.

While the electrode cell 110 of this embodiment of the present invention has been shown and described as being formed in a pouch type, the electrode cell 110 is not limited thereto but may be formed in a wound type in which the cathode 111, the anode 112 and the separator 113 are wound in a roll shape.

The electrode cell 110 is immersed in the electrolyte. At this time, the cathode active material layer 111b, the anode active material layer 112b and the separator 113 may be immersed in the electrolyte.

The electrolyte may function as a medium that can move lithium ions, and may include an electrolytic material and solution. Here, the electrolytic material may include any one lithium salt of LiPF6, LiBF4 and LiClO4. Here, the lithium salt may function as a source of lithium ions doped to the anode upon charge of the lithium ion capacitor.

In addition, the electrolyte may be made of a material capable of keeping the lithium ions stable without generating electrolysis under the high voltage. Accordingly, the solvent of the electrolyte may be the carbonate group solvent. The examples of the carbonate group solvent may be any one or mixed solvent of two or more selected from propylene carbonate, ethylene carbonate, diethyl carbonate, dimethyl carbonate, and ethyl methyl carbonate.

In addition, the cathode terminal 120 and the anode terminal 130 may include insulating members 140 installed at portions of upper and lower parts thereof, respectively. The insulating members 140 may function to secure insulation between the cathode terminal 120, the anode terminal 130 and the housing 150, which is to be described.

The separator 113 may function to electrically separate the cathode 111 and the anode 112 from each other. While the separator 113 may be formed of paper or non-woven fabric, kinds of the separator in the embodiment of the present invention is not limited thereto.

While the electrode cell 110 of this embodiment of the present invention has been shown and described as being formed in a pouch type, the electrode cell 110 is not limited thereto but may be formed in a wound type in which the cathode 111, the anode 112 and the separator 113 are wound in a roll shape.

The electrode cell 110 is immersed in the electrolyte. At this time, the cathode active material layer 111b of the cathode layer 111, the anode active material layer 112b of the anode 112 and the separator 113 may be immersed in the electrolyte.

The electrolyte may function as a medium that can move lithium ions, and may include an electrolytic material and solution. Here, the electrolytic material may include any one lithium salt of LiPF₆, LiBF₄ and LiClO₄. Here, the lithium salt may function as a source of lithium ions doped to the anode upon charge of the lithium ion capacitor. In addition, a material used as solvent in the electrolyte may be any one or mixed solvent of two or more selected from propylene carbonate, ethylene carbonate, diethyl carbonate, dimethyl carbonate, and ethyl methyl carbonate.

The electrode cell 110 immersed in the electrolyte may be sealed by the housing 150. Here, while the housing 150 may be formed by hot-melting two sheets of laminated films, the housing 150 of the embodiment of the present invention is not limited thereto but may be formed of a metal can.

Therefore, as described in the embodiment of the present invention, since the electrostatic capacitance can be increased by including the cathode active material layer including the first active material made of the composite material of carbon/lithium metal oxide and the second active material made of charcoal, it can reduce the thickness of the cathode with maintaining the conventional electrostatic capacitance.

In addition, by including the first and the second active materials as described in the embodiment of the present invention, the manufacturing of the slutty may be easy in comparison with a case that only the first active material is included.

In addition, as described in the embodiment of the present invention, by reducing the thickness of the cathode due to the capacitance increment of the cathode active materials, the inner resistance in the cathode can be reduced, which will, in turn, the output property of the lithium ion capacitor is improved.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A lithium ion capacitor including cathodes and anodes alternately disposed with the separators interposed therebetween,
wherein the cathode comprises a cathode collector and a cathode active material layer made of a first cathode active material layer disposed on at least one surface of the cathode collector and made of carbon/lithium metal oxide and a second cathode active material made of charcoal.

2. The lithium ion capacitor according to claim 1, wherein the carbon includes any one among a carbon nano tube and a graphene.

3. The lithium ion capacitor according to claim 1, wherein the cathode active material layer further includes a conductive material.

4. The lithium ion capacitor according to claim 3, wherein the conductive material includes any one among carbon black, acetylene black, graphite and metal powder.

5. The lithium ion capacitor according to claim 1, wherein the anode includes an anode collector and an anode active material layer disposed at least one surface of the anode collector.

6. The lithium ion capacitor according to claim 5, wherein the anode active material layer includes any one among natural graphite, artificial graphite, graphitized carbon fiber and hard carbon and a carbon nano tube.

7. The lithium ion capacitor according to claim 5, wherein the anode active material pre-dopes lithium ions.

8. The lithium ion capacitor according to claim 1, wherein the second active material has a weight ratio of 1 to 5 times in comparison with the first active layer.
